(19) United States
(12) Patent Application Publication
(10) Pub. No.: US 2015/0170101 A1
(43) Pub. Date: Jun. 18, 2015

(54) Electronic Platform and System for Obtaining Direct Interaction with Celebrities

(71) Applicants: Tamera Fair, Chicago, IL (US); Dorothy Loades, Dallas, TX (US); Dana Lambert, Dallas, TX (US); Jeff Goldberg, Buffalo Grove, IL (US)

(72) Inventors: Tamera Fair, Chicago, IL (US); Dorothy Loades, Dallas, TX (US); Dana Lambert, Dallas, TX (US); Jeff Goldberg, Buffalo Grove, IL (US)

(21) Appl. No.: 14/567,640

(22) Filed: Dec. 11, 2014

Related U.S. Application Data
(60) Provisional application No. 61/915,666, filed on Dec. 13, 2013.

(51) Int. Cl. G06Q 10/10

(52) U.S. Cl. CPC G06Q 10/101

(57) ABSTRACT

An electronic platform and system for obtaining direct interaction with celebrities including a computer implemented and internet based system for conducting an involvement contest to win a personalized session to interact with a designated celebrity. The system identifies and categorizes different celebrities and announces a set of predetermined participating celebrities in each category. Users send in submissions including content of limited length and predetermined payment with each submission. The submissions are processed through a set of unique reviewing, grading, and selecting procedures to determine their eligibility. The submissions are filtered and graded by a computer-based filter and grading functional block and the graded messages are ranked and preselected based on the scores they were given. The final winner is based on the results of a manual selection process and is awarded an online interaction session with the selected celebrity for that contest.

This application claims priority to the U.S. Provisional Patent Application Ser. No. 61/915,666, filed Dec. 13, 2013, which is incorporated herein.

### FIELD OF THE INVENTION

The present disclosure relates to a filtering and selecting process to determine a client entitled to a direct interaction with a designated celebrity or certain celebrities. In particular, the present platform and system provide information and payment submission modules and a filtering and selection process. The system will provide the audience members individual interactive sessions with the designated celebrities.

### BACKGROUND OF THE INVENTION

Celebrities are those who have a prominent profile and command some degree of public fascination and influence in day-to-day media. A celebrity may be fictional or non-fictional. Actors, singers, writers, athletes, models, politicians, experts in their fields of endeavor, business leaders, and the like can all be qualified as celebrities. Among these professional activities in the fields commonly associated with celebrity prestige, the entertainment and sports industries are the most prominent careers that offer celebrity status.

Because of their fame and publicity of the nature of the work the celebrities are involved with, there is a strong public curiosity about the celebrities' private affairs. Fans tend to harbor a desire to interact with their favorite celebrities. A desire for personal interactions between fans and celebrities exists due to the high demand of the fans' desire to see, talk, or share experiences with the celebrities they admire. These interactions are usually rare due to the celebrities' schedule, and expensive due to the high price for the celebrities' personal appearance time and their extreme bargaining power in these transactions.

Common present personal interactions with celebrities include backstage passes and prearranged meetings. These meetings may be one-to-one or in groups. These opportunities however, are not usually widely available to the general public. Other forms of personal meetings such as meal arrangements through an auction, whose proceedings are typically donated to charity, are realistically only available to those fans having the resources to afford these kinds of arrangements.

One problem with the actual face-to-face interactions is that these arrangements are time consuming and expensive to implement. The arrangements will be subjected to the schedule of the celebrities. The celebrities on the other hand, are concerned about their image, and usually reluctant to purely “sell” their time and presence to anyone willing to pay. The auctions are likely to picture the participating celebrity as a self-centered person and in turn diminish the aura of mystique of the celebrity or degrade the celebrity's image. Such direct personal face-to-face interactions may also bring privacy and safety concerns. These interactions often involve elaborate security precautions.

Since the beginning of the Internet era, the World Wide Web has become an important vehicle for fans to interact with celebrities. Virtual online interactions with celebrities have been provided by various websites. Prior art references that disclose computer implemented paid individual interactions between fans and celebrities are U.S. patent application Ser. No. 11/419,971 and U.S. patent application Ser. No. 11/977,570. These disclosures relate to methods for commercializing a celebrity's time for individual interactions with a buyer.

U.S. patent application Ser. No. 11/419,971 titled “Charitable Online Interactive System” relates to a charitable guest reservable online celebrity interaction between a guest and a celebrity via a network. The system receives reservation data including at least a time to conduct the interaction via the network, provides an online interactive environment to conduct the interaction between guest and celebrity, and processes payment from the guest whereby at least a portion of the payment is provided to the charity and another portion is provided to the celebrity. (¶¶[0016-18]).

In the computer-implemented method described in the '971 application, an online direct interaction with a selected celebrity is provided to the users of the system. The users, through an auction, obtain the virtual direct interaction arranged and monitored by the system. (FIG. 1A, ¶¶[0071-72], ¶ [0037] “During the interactive session, a website host and/or celebrity may, in an embodiment, terminate an interactive session if the guest fails to abide by the user agreement and/or code of conduct. Embodiments of the invention include apparatus and methods for facilitating the termination process and any settlement that may be required thereafter.”)

U.S. patent application Ser. No. 11/977,570 titled “System for Interaction with Celebrities” relates to a method for commercializing a celebrity's time, comprising the steps of: defining a session for interaction with a celebrity; offering the session for sale via a medium, such as the internet; and accepting an offer from a buyer and scheduling the session with the buyer such that said celebrity is obligated to interact with the user during the session.

The system described in the '570 application offers the buyer a session to interact with a celebrity via an internet website. The sale is offered to general users, a restricted group of members of a subgroup of these users, to journalists only, or to the professional consultants of celebrities (¶¶[0046-49]). The price of the offered session can be concluded by the buyer offering a predetermined price or by the successful buyer bidding a highest price within a predetermined time frame (¶¶[0044-45]).

These prior art systems, however, do not provide a wide range of participating experience to their users. While everyone can participate in the bidding during the auction, only the highest bidder can become the buyer of the interaction with the celebrities. This will discourage other fans who don't have the amount of money to win the auction. Also, the provider of these sessions can only collect the winning bid from the winner. The losing parties do not have to pay for the losing bids during the auction. Moreover, the participating celebrity does not have any choice or control of the incoming session that he/she is obligated to join. Even though the prior art systems disclosed some filtering or monitoring processes, they do not provide the participating celebrities with the flexibility to pick, choose or show his/her personal preference. In other words, there lacks a system that provides the broad participation of a wide range of users, and can give the participating celebrities an opportunity to show their preferences.

### SUMMARY OF THE INVENTION

The present invention relates to a computer implemented and Internet based system for conducting an involvement contest to win a personalized session to interact with a designated celebrity. The system identifies and categorizes different celebrities and announces a set of predetermined participating celebrities in each category. The system allows users to send in a submission including a content of limited length, and a predetermined payment with each submission. The submissions will processed through a set of unique reviewing, grading, and selecting procedures to determine their eligibility to become the winner of the offered interaction with the designated celebrity. More specifically, the submitted content will be filtered and graded by a computer based filter and grading functional block. The graded messages will be ranked and preselected based on the scores they got. The content with limited length from the preselected messages will be provided to the manual selection center for manual selection. The final winner is based on the result of the manual selection process. The final winner of the direct interaction will be awarded an online interaction session with the selected celebrity for that contest.

The provided system fills the market demand for the general fan group's desire to directly interact their selected celebrities.

### BRIEF DESCRIPTION OF THE DRAWINGS

The features of the present invention which are believed to be novel are set forth with particularity in the appended claims. The invention may best be understood from the following detailed description of currently illustrated embodiments thereof taken in conjunction with the accompanying drawings wherein like numerals refer to like parts, and in which:

FIG. 1 is a flow chart showing the computer based platform for obtaining direct interaction with selected celebrities.

FIG. 2 is a flow chart showing the celebrities categorizing processes.

FIG. 3 is a flow chart of the filtering and selecting process for the winner of the direct interaction.

### DETAILED DESCRIPTION OF THE INVENTION

The present invention comprises a computer and Internet based platform for obtaining direct interaction with celebrities, and a sophisticated selecting and processing process to determine the winner of the interaction session. The system is typically computer implemented and Internet based. Specific details are set forth in the following description to provide a thorough understanding of the present invention.

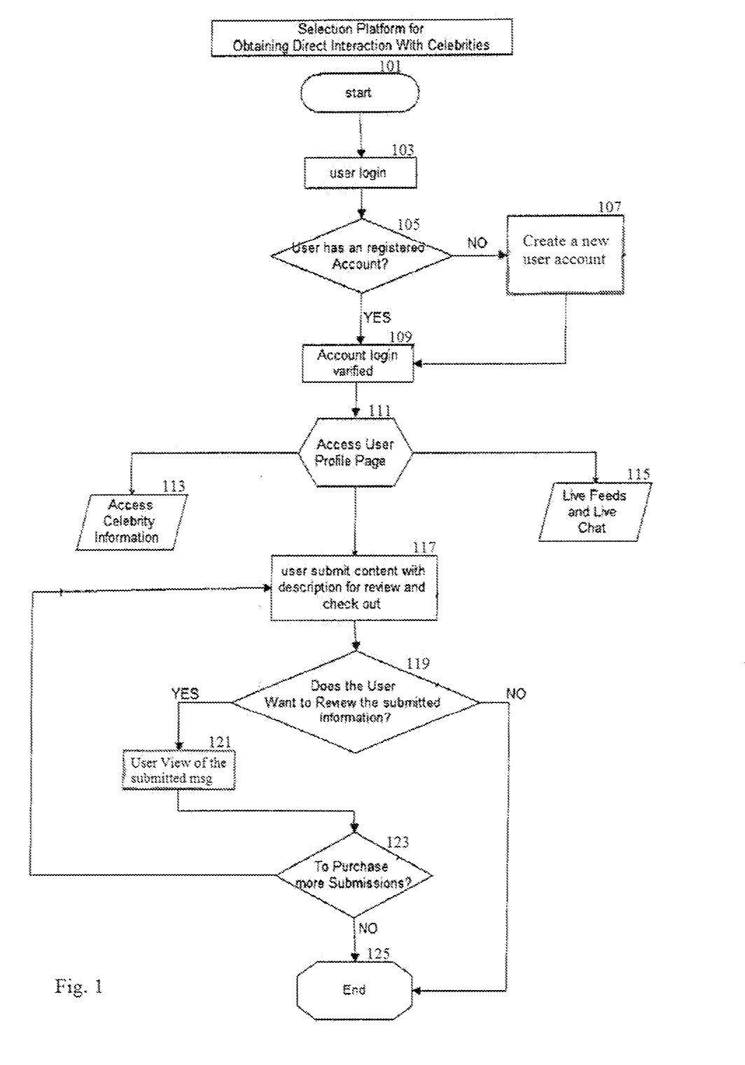

Various embodiments of methods and techniques are described hereinbelow. In accordance with the embodiment illustrated in FIG. 1, the users can access through the World Wide Web to be admitted to the system and participate in the selecting process to obtain direct interaction with celebrities. At step 101, the users obtain access to start their process of being selected to have a direct interaction with their selected celebrities. The users visit the system through a webpage browser on their computer or mobile device to arrive at a webpage of the system's website. The webpage includes a document written in PHP Script, JAVA Script, HTML (HyperText Markup Language), XHTML (Extensible HyperText Markup Language), WML (Wireless Markup Language) or an equivalent language, and containing visual or auditory information.

The users may browse the system's website for general information including: the individual profile pages for the listed celebrities on the website, the information of the website, the rules, and eligibility and procedures of becoming a winner of the direct interaction with their selected celebrities. Some exclusive information is only available to registered users. The users may access this information with their valid client logins 103. Step 105 shows the system verifying the client's login information. If the user is a new user and desires to register for a client account, the user will be directed to the “create new account” page at step 107. At step 107 the user will submit account information, including but not limited to: user name, account password, and email address to receive a confirmation letter, subscribe to the information from the system website, and find the password if the password is forgotten.

Once the new client is registered for an account, the new client will be logged in automatically at step 109. The users with an existing account can log in when the login information is verified. Once the user logs in, the user will access user profile page at step 111. Logged in users can view the past interactions they were involved in, and the content they have already submitted previously since the user account was created. The user profile page also provides access to the celebrity information at step 113. The celebrity information includes the user's subscribed celebrities' information, and the identity of current and upcoming celebrities participating in the direct interaction sessions. The user profile pages also provide live news feeds and chatting functions with other registered users as shown at 115. The users can manage their accounts, edit their profiles, view the status of their purchased options, and make purchasing decisions based on their judgment of their chances of winning under the user profile page. The users will also have access to direct interaction when they are selected as winners in a particular direct interaction session. The participating celebrities may be categorized by their publicity and popularity.

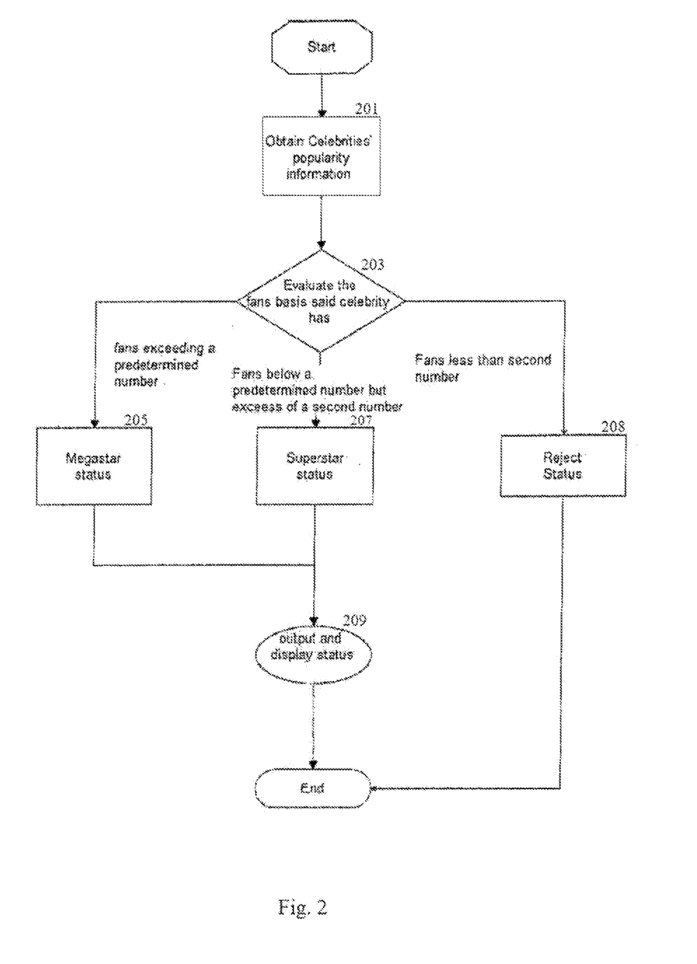

One embodiment of the celebrities' categorizing process is illustrated in FIG. 2. At 201, the system collects the celebrities' followers/fans data from their existing social media websites/accounts, such as on Facebook, Twitter, and Instagram. The system uses the numbers collected from the social media websites to evaluate the fan's basis of the celebrity. At step 203, the numbers of followers/fans from the exiting social media are combined and result in a total fans number. The system then compares the resulted fans number to a predetermined threshold number, for example 10 million. At step 205, when the fans number of the celebrity exceeds the threshold number, the system will assign the Megastar status to the celebrity being evaluated. At step 207, if the number does not exceed the threshold number but still exceeds a second number, the system will assign the Superstar status to the celebrity. The system will deny the recognition of a celebrity's status if the fan number is less than the second predetermined number at step 208. The assigned statuses of the celebrities are then output by the system and displayed at step 209. The assigned statuses are later displayed on the system's website with the celebrities' information, and also in the selecting process described hereinafter.

A number of celebrities from these categories are invited to participate in the final direct interaction sessions. When the contest is open for submission and a user decides to purchase a submission to participate in the process to win the prize, the users will be directed to the submission, purchasing, and checking out process at step 117 in FIG. 1.

At step 117, the user will be directed to compose a short content with limited length related with the celebrity the user is aiming to connect with. The user is instructed to use his/her own judgment to select the most relevant words that can get their submission rated at a higher score, and avoid the words disqualifying their submission from being excluded. The user is instructed to include a limited words message with their submission. This included statement can be any expression that the user desires to include, for example, their intent in participating in the contest, their proposed topics to discuss with their selected celebrities, their feelings about the celebrity, or their wishes to the celebrity. This statement will be submitted as one submission that will be filtered, graded, and selected by the system.

Each submission is also accompanied by a fee that the user is obligated to pay at check out as shown in step 117. The submission fee is a relatively small amount of money. Failure to pay the fee will prevent the user from proceeding to submit the statement to the system. Therefore, the non-paying submission can never be selected as the winner. Payment information is provided by the user at the check-out page. A merchant API script is connected to the payment information form in which the user inserts their credit card and relevant information. The payment page is protected by an encrypted SSL certificate and the information is processed by the system's merchant portal. The merchant will approve the transaction once the card information is verified. Once the merchant approves the transaction, the submission will be accepted by the system and posted on the user's submission information page for the user to review the content of the submission and check the status of the submission during the contest. When the transaction is not successful, the submission will not be accepted and it will not be posted at the user's submission information page.

Once the submission is posted at the user's submission information page, the user will have the authority to review the submitted information at step 119. The user so choosing to view the submitted information will be directed to the user's view page at step 121. The user's view page allows the user to read the submitted information, but will not allow any modification to the already submitted information, or delete the submission.

In the user's judgment at step 123, the user can decide whether to purchase more opportunities to submit their statements. Purchasing more submissions can enhance the user's chances of obtaining a higher score and eventually being selected to obtain the direct interaction with the celebrities. All of the submissions purchased and paid by the user can be later reviewed by the user, but the submissions cannot be revoked or modified once they are submitted. A user can obtain relevant information from the user's profile page or through the live feeds and chat functions at step 115 to determine the content to be submitted. The participating celebrity's profile page also provides resources at step 113 for the users to find out what they want to put in their submissions. Each registered user's submission is independent from other users. The users do not have the authority to review submissions from other users.

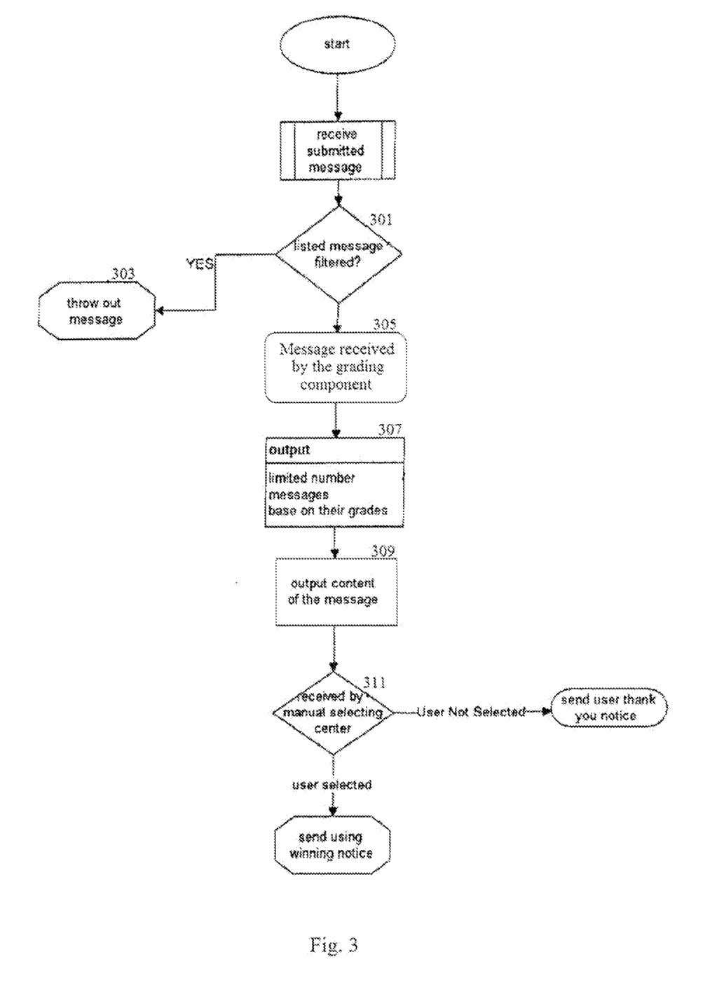

All of the entries accepted from the users are saved in a backend database in the system for selecting and processing. FIG. 3 illustrates the detailed steps of the winner selection process. The system processes the submitted content at step 301. The system is preloaded with a list of filtering keywords that will disqualify a submission from being selected. In one embodiment of the invention, the disqualifying words are prepared by the participating celebrity or his/her agent(s)/representative(s). The system conducts a word match at step 301 between the disqualifying words list and the user's submitted content. A submission will be thrown out at step 303 when one of the disqualifying words is found in the user's submission. Throw-out messages lose their chances to be selected as the final winner for the direct interaction with the celebrities.

After the preliminary filtering process at step 301, the remaining messages will be sent to the grading component of the system. The messages will then be processed at the grading component at step 305. The grading component comprises a list of keywords with one score assigned to each scoring keywords. For example, for a famous basketball player, the evaluating keywords maybe designed as MVP +10, all-star +9, patient +7, bulls +4, playoffs +1, Memphis +5, Simeon +11, superstar −2, injury −5, trade −7, etc. In one embodiment of the invention, the keywords and assigning scores are prepared by the website staffs or the participating celebrity's agent, and approved by the celebrity. The celebrities can also prepare the list and assign scores themselves. The grading component will go through each content it receives at step 305 and evaluate the scores of the user's submission by calculating the final score after adding all the assigned scores to each word in the submission. Each user can submit multiple submissions, and each submission is graded independently in the contest.

All the submissions graded by the grading component at step 305 are ranked by their scores from high to low at step 307. A predetermined number is loaded to the system at step 307 to limit the number of messages advancing to the final manual selection. At step 307, the system pops out a limited number of submissions from the one that has the highest score based on their rankings. In one embodiment, the system pops out one hundred submissions based on the scores of their submissions. The statement message submitted in each submission is also popped out by the system for review.

At step 309, the statement messaged from each submission selected from step 309 is extracted from the submission and listed in the same order as the order of the submissions. The extracted statements are then sent to the manual selecting center at step 311. In one embodiment of the present invention, the extracted statements are sent to the manual selecting center with related information such as the participant's profile, the time and date of the preselected submission, and/or the participant's relevant account activities, etc.

The manual selection center implements a selection process purely based on a human's discretion rather than any kind of artificial intelligence. In one embodiment of the present invention, the participating celebrity does the final selection from the limited statements to determine who is the winner of the direct interaction with her/him. Because the celebrity is the one responding to the fan's request for direct interaction, the celebrity is in the best position to control the party he/she speaks with and the topic of the conversation. The manual selection and determination can also be conducted by the celebrity's agent that shares a similar position as the celebrity.

The celebrities' concern with their image and safety still exists when the interaction with their fans is strictly limited over the virtual online interacting methods of the present system. Celebrities are concerned with the activities they are involved with that might lower their image or twist their public recognition. However, the process disclosed herein employs both a computer filtering and evaluating process and a manual selection process to ensure the final winner who is granted the reward truly appreciates the opportunity to interact with the selected celebrity. The process also provides the celebrities an opportunity to reward their fans that know each celebrity the best. This important feature of the present system is significantly different from the prior art systems that provide the celebrity interaction opportunity to whoever pays the highest price to buy the celebrity's time, or systems that just randomly pick a winner from a number of participants. One other significant distinction between the present invention and prior art systems is the participating users do not have to advance a relatively large amount of money to win the prize to interact with their favorite celebrities. Unlike an auction or a bid on the celebrity's time, where whoever pays the greatest amount of money wins the chance, the present system focuses more on helping the users to express themselves and decide what will bring them to the celebrity based on their knowledge about that certain celebrity. This will enhance the public's involvement into the contest and will not deter the users who are not able to take on a significant financial obligation to purchase a celebrity's time.

The disclosed method creates an instant and constant revenue stream. Instead of collecting only the bid winner's money that he or she is willing to pay for the interaction, the present business method collects a small amount of money from a large amount of participating users and can potentially create a larger income stream than the prior art systems. It also offers the users on both ends an opportunity to know each other and enhance their connections.

While one particular embodiment of an electronic platform and system for obtaining direct interaction with celebrities of the present invention has been shown and described, it will be apparent to those skilled in the art that changes and modifications may be made without departing from the true spirit and scope of the present invention. It is the intent of the appended claims to cover all such changes and modifications as fall within the true spirit and scope of the invention.

1. A method for commercializing a direct interaction with a celebrity, comprising:
a. categorizing a group of selected celebrities into a plurality of status categories;
b. directing a plurality of clients to compose and submit a statement with a limited length;
c. collecting a predetermined amount of money from said plurality of clients;
d. accepting submissions from said plurality of clients, each submission is associated with one of said celebrities;
e. filtering said statement and obtaining a disqualified group of submissions and a qualified group of submissions;
f. excluding said disqualified submissions;
g. grading said qualified group of submissions and assigning one score to each graded submission;
h. selecting at least one winning submission; and
i. awarding the at least one client who submitted the selected winning submission with at least one online direct interaction session with said submission associated celebrity.

2. The method for commercializing a direct interaction with a celebrity of claim 1, said method comprising: ranking said graded submissions according to the assigned scores.

3. The method for commercializing a direct interaction with a celebrity of claim 1, said method comprising: categorizing said group of celebrities based on their publicity and popularity.

4. The method for commercializing a direct interaction with a celebrity of claim 1, said method comprising: collecting said clients' credit card information to collect said predetermined amount of money.

5. The method for commercializing a direct interaction with a celebrity of claim 1, said method comprising: collecting said clients' personal information through their existing social media accounts.

6. The method for commercializing a direct interaction with a celebrity of claim 1, said method comprising: posting the collected clients' submissions on the submitting client's information page, and authorizing the submitting client to view the submitted statement.

7. The method for commercializing a direct interaction with a celebrity of claim 1, said method comprising: providing a list of filtering keywords that will disqualify a statement from being selected by the participating celebrity or representative.

8. The method for commercializing a direct interaction with a celebrity of claim 7, said method comprising: word matching between the filtering keywords and the submitted statement, and disqualifying a submitted statement when one of the disqualifying keywords is found in the submitted statement.

9. The method for commercializing a direct interaction with a celebrity of claim 1, said method comprising: providing a list of scoring keywords with one score assigned to each scoring keyword.

10. The method for commercializing a direct interaction with a celebrity of claim 9, said method comprising: grading the submitted statement by adding up the assigned score of each matched scoring keyword in the submitted statement.

11. The method for commercializing a direct interaction with a celebrity of claim 10, said method comprising: ranking the submissions according to the scores they received in the grading in an order from higher scores to lower scores.

12. The method for commercializing a direct interaction with a celebrity of claim 11, said method comprising: loading a predetermined number of submissions according to their rankings into a manual selecting process.

13. The method for commercializing a direct interaction with a celebrity of claim 1, said winning submission selecting process comprising: manually selecting at least one winning submission based on at least one determine factor.

14. The method for commercializing a direct interaction with a celebrity of claim 13, said at least one determine factor comprising: the grading results of said submission, a profile information of said submitting client, the time and date of said submission, and a relevant account activities of said submitting client.
